(19) United States
(12) Patent Application Publication
(10) Pub. No.: US 2023/0291296 A1
(43) Pub. Date: Sep. 14, 2023

(54) Magnetic Cylinder Gear System

(71) Applicant: Jose M Cortes, LaPlace, LA (US)

(72) Inventor: Jose M Cortes, LaPlace, LA (US)

(21) Appl. No.: 18/199,210

(22) Filed: May 18, 2023

(51) Int. Cl. H02K 49/10

(52) U.S. Cl. CPC H02K 49/102

(57) ABSTRACT

A magnetic cylinder gear system includes an electric motor, a first cylindrical body, at least a first rectangular magnet, a second cylindrical body and at least a second rectangular magnet. The electric motor has a first rotatable drive shaft terminally and concentrically connected to the first cylindrical body. The first cylindrical body is positioned closely adjacent the second cylindrical body such that in an initial position a North polarity of the first rectangular magnet imparts magnetic attraction to a South polarity of the second rectangular magnet. In a rotated position, the South polarity of the first rectangular magnet imparts magnetic attraction to a North polarity of the second rectangular magnet such that a rotation of the first cylindrical body in a clockwise direction imparts a corresponding counter-clockwise rotation of the second cylindrical body, thereby driving the second cylindrical body without physical contact between the first cylindrical body and the second cylindrical body.

### BACKGROUND OF THE INVENTION

### Field of the Invention

The present invention relates to the field of a gear system, and more particularly, to a magnetic gear system for the transfer of power.

### Description of the Related Art

The power transmission is mechanical in most machines, and it is commonly achieved through gear transmissions. Mechanical gear transmissions have a high torque density, but friction occurs in them, which is often the cause of gear failure. Also, noise, heat and vibration are present, so the reliability and longevity of these gears is reduced. Gears and gear systems can be used in many different types of mechanical devices and for many different purposes. Gears are used in vehicle transmissions, wind turbines, elevators, helicopters and the like.

Also, in the traditional energy-generating apparatus, gear systems are used where the motor generates kinetic energy through rotation. Motors and generators generate kinetic energy and electric energy, respectively, and use permanent magnets to generate electricity.

Conventionally, the renewable electric power which is generated is based on the well-known Faraday’s law of electromagnetic induction by using permanent magnets for generating electricity.

In order to produce electricity, there is a need of high powered magnets like neodymium Magnets which have high magnetic strength, a DC generator for converting the mechanical motion of the shaft to electric energy, a Spur gear to transfer mechanical motion as well as control speed, power and torque and a battery to store the electric energy.

Conventionally, two round gears of different sizes can be used to alter the speed and direction of rotational force. This includes changing the direction of the rotation or changing the rotational axis from vertical to horizontal and the like. Gears can also be used to change torque.

The biggest problem with conventional gears and gear systems is the loss of energy due to friction caused by the gears mechanically connecting, mating or engaging. Conventional gears and gear systems also experience significant stresses due to their interaction with other gears which often leads to failure of the gears and gear systems. In order to overcome these issues, several magnetic gear systems have been created. These gear systems are contactless and frictionless. Therefore, the magnetic gears and gear systems lose less energy and experience less stress than traditional gears and gear systems.

Conventional motors typically rely on a defined input power source to produce an output; may it be a mechanical or electrical output. Such motors typically rely on magnetic generators to either convert an electrical input to a mechanical output, or to convert a mechanical input to an electrical output. Although these motors may include numerous magnetic sources, and rely on the electromotive force to operate, few utilize these magnetic sources to actually provide, or enhance the input power supplied to the motor.

In addition, motors that rely on magnets for an input force will wear down and stop operating over time due to friction forces existing between component parts and magnetic devices. Such devices may operate for a short time but cannot continuously operate over an extended period of time. With the development of technology, one object of the present invention is to develop other ways of power and torque transmissions, whereby the noise, vibration, maintenance costs, and the like would be lower. One of those ways is the use of magnets in power transmission.

Despite these numerous systems, there is a need for a magnetic gear system that has a magnet arrangement that maximizes the use of the magnetic fields and potential energy of the magnets to aid the transfer of energy through the magnetic gear system.

Accordingly, there is a need in the art for a motor that can generate torque and produce energy that utilizes magnetic devices as an input force, and may also operate for a longer time.

The present invention overcomes certain limitations of conventional gear systems by providing a unique arrangement of cylinders that are rotatable with respect to each other to modify a radial air gap between the cylinders. The intensity of a magnetic field in the air gap varies as the magnetic poles are moved into and out of alignment with each other. This arrangement provides mounting and demounting of gears with greater ease than before, while also providing a cylinder construction that has numerous advantages.

One main object of the present invention is to overcome the disadvantages of prior art. Another object of the present invention is to provide for a more efficient power transmission system. Yet another object of the present invention is to provide a magnetic gear system that transfers power in a frictionless manner and without mechanical connections between the gears, without being dependent on expensive or complex components. Yet another object of the present invention is to provide a frictionless gear system for electricity generation. Embodiments of the present invention provide for devices and methods and disclosed herein and as defined in the annexed claims which provide for improved power transmission gear systems and electrical generation systems.

### SUMMARY OF THE INVENTION

It is one prospect of the present invention to provide one or more novel devices of simple but effective construction which may be applied to many appliances which use gear systems.

The following presents a simplified summary of the present disclosure in a simplified form as a prelude to the more detailed description that is presented herein.

Therefore, in accordance with embodiments of the invention, there is provided a magnetic cylinder gear system. The magnetic cylinder gear system includes an electric motor, a first cylindrical body, at least a first rectangular magnet, a second cylindrical body and at least a second rectangular magnet.

The electric motor has at least a first rotatable drive shaft having a proximal end opposite a distal end. The proximal end is operatively connected to the electric motor. The first cylindrical body defines a first cylindrical cavity. The first cylindrical body comprises a first cylindrical body longitudinal axis. Preferably, the first cylindrical body includes a first end wall opposite a second end wall. In a preferred embodiment, the distal end of the at least first rotatable drive shaft is terminally and concentrically connected to the first end wall of the first cylindrical body.

The first rectangular magnet is concentrically disposed within the cylindrical cavity of the first cylindrical body. The first rectangular magnet comprises a longitudinal axis in co-axial alignment with the first cylindrical body longitudinal axis.

The first rectangular magnet includes a North polarity opposite a South polarity. The first rectangular magnet includes a dividing line between the North polarity and the South polarity. The dividing line of said first rectangular magnet is in co-axial alignment with the cylindrical body longitudinal axis.

Further, the magnetic cylinder gear system provides a second cylindrical body defining a second cylindrical cavity. The second cylindrical body includes a second cylindrical body longitudinal axis. The second cylindrical body includes a first end wall opposite a second end wall. The second cylindrical body is concentrically disposed between a first driven axle and a second driven axle. The first driven axle is terminally and concentrically connected to the first end wall of the second cylindrical body.

Preferably, the second driven axle is terminally and concentrically connected to the second end wall of the second cylindrical body. The second rectangular magnet is concentrically disposed within the cylindrical cavity of the second cylindrical body. The second rectangular magnet includes a longitudinal axis in co-axial alignment with the second cylindrical body longitudinal axis.

The second rectangular magnet includes a North polarity opposite a South polarity. The second rectangular magnet includes a dividing line between the North polarity and the South polarity. The dividing line of the second rectangular magnet is in co-axial alignment with the second cylindrical body longitudinal axis. The first cylindrical body is being positioned closely adjacent the second cylindrical body such that in an initial position the North polarity of the at least first rectangular magnet imparts magnetic attraction to the South polarity of the at least second rectangular magnet and in a rotated position the South polarity of the at least first rectangular magnet imparts magnetic attraction to the North polarity of the at least second rectangular magnet such that a rotation of the first cylindrical body in a clockwise direction imparts a corresponding counter clockwise rotation of the second cylindrical body.

In yet another embodiment, there is provided a third cylindrical body and at least a third rectangular magnet. The third cylindrical body defining a third cylindrical cavity. The third cylindrical body having a third cylindrical body longitudinal axis. The third cylindrical body includes a first end wall opposite a second end wall. The third cylindrical body is concentrically disposed between a third driven axle and a fourth driven axle.

Preferably, the third driven axle is terminally and concentrically connected to the first end wall of the third cylindrical body. The fourth driven axle is terminally and concentrically connected to the second end wall of the third cylindrical body. The third rectangular magnet is concentrically disposed within the cylindrical cavity of the third cylindrical body. The third rectangular magnet comprises a longitudinal axis in co-axial alignment with the third cylindrical body longitudinal axis.

The third rectangular magnet includes a North polarity opposite a South polarity. The third rectangular magnet includes a dividing line between said North polarity and the South polarity. The dividing line of the third rectangular magnet is in co-axial alignment with the third cylindrical body longitudinal axis. The first cylindrical body is being positioned closely adjacent the third cylindrical body such that in an initial position the North polarity of the at least first rectangular magnet imparts magnetic attraction to the South polarity of the at least third rectangular magnet. In a rotated position the South polarity of the at least first rectangular magnet imparts magnetic attraction to the North polarity of the at least third rectangular magnet, such that a rotation of the first cylindrical body in a clockwise direction imparts a corresponding counterclockwise rotation of the third cylindrical body.

These and other features, aspects, and advantages of the present invention will become better understood with reference to the following description and appended claims.

### BRIEF DESCRIPTION OF DRAWINGS

Illustrative embodiments of the present invention are described herein with reference to the accompanying drawings, in which like numerals throughout the figures identify substantially similar components, in which:

FIG. 1 is a perspective view of a magnetic spin cylinder gear system, in accordance with embodiments of the invention;

FIG. 2 is a perspective view of a first cylindrical body, in accordance with embodiments of the invention;

FIG. 3 is an open view of the first cylindrical body in accordance with embodiments of the invention;

FIG. 4 is a perspective view of the arrangement of the first cylindrical body and a second cylindrical body with an exemplary electric motor, in accordance with embodiments of the invention;

FIG. 5 illustrates a perspective view of arrangement of the first cylindrical body, the second cylindrical body and a third cylindrical body, in accordance with embodiments of the invention;

FIG. 6 illustrates a perspective view of the second cylindrical body, in accordance with embodiments of the present invention;

FIG. 7 is an open view of the second cylindrical body, in accordance with embodiments of the invention;

FIG. 8 is an open view of the third cylindrical body, in accordance with embodiments of the invention; and

FIG. 9 is another open view of the third cylindrical body, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein are solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers, or steps. Likewise, the term “comprising” is considered synonymous with the terms “including” or “containing” for applicable legal purposes. Any discussion of documents acts, materials, devices, articles, and the like are included in the specification solely for the purpose of providing a context for the present invention. It is not suggested or represented that any or all these matters form part of the prior art base or were common general knowledge in the field relevant to the present invention.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, several materials are identified as suitable for various facets of the implementations.

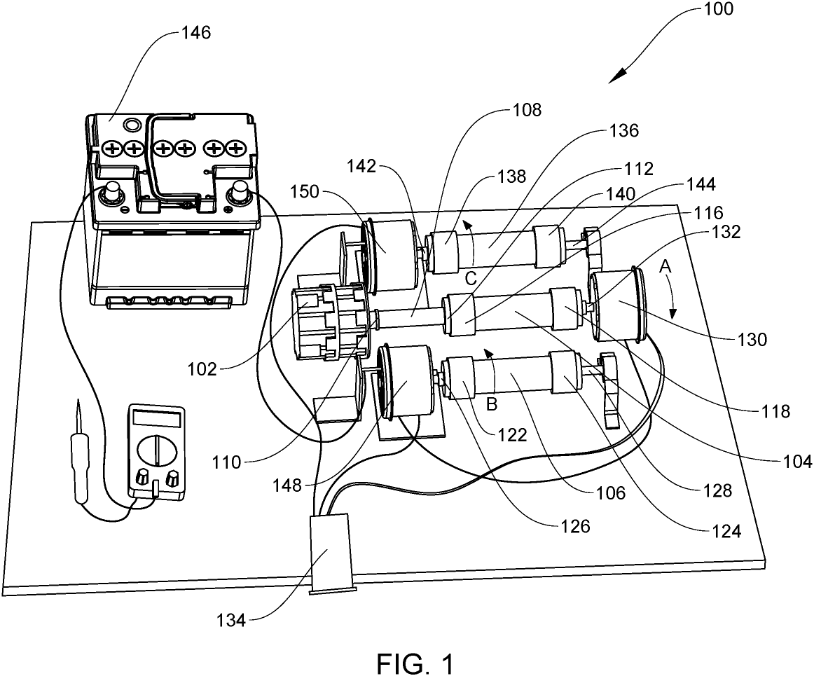

Referring initially to FIGS. 1-9, the basic constructional details and principles of operation of embodiments of a magnetic cylinder gear system 100 according to preferred embodiments of the present invention will be discussed.

FIG. 1 is a perspective view of a magnetic spin cylinder gear system, in accordance with embodiments of the invention. As illustrated in FIG. 1, a magnetic cylinder gear system 100 preferably includes an electric motor 102, a first cylindrical body 104, at least a first rectangular magnet (shown in FIGS. 3, 7 and 8), a second cylindrical body 106 and at least a second rectangular magnet (explain in FIGS. 3, 7 and 8).

The electric motor 102 comprises at least a first rotatable drive shaft 108. The first rotatable drive shaft 108 has a proximal end 110 opposite a distal end 112. The proximal end 110 is operatively connected to the electric motor 102 and the distal end 112 is operably connected to the first cylindrical body 104.

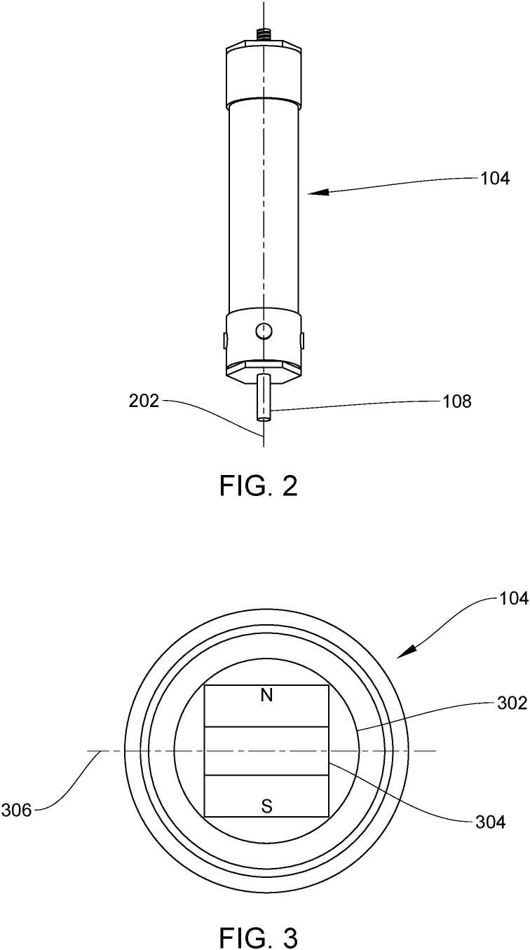

The first cylindrical body 104 is defining a first cylindrical cavity. The first cylindrical body 104 comprises a first cylindrical body longitudinal axis (202, shown in FIG. 2). The first cylindrical body 104 includes a first end wall 116 opposite a second end wall 118. The distal end 112 of the at least first rotatable drive shaft 108 is terminally and concentrically connected to the first end wall 116 of the first cylindrical body 104.

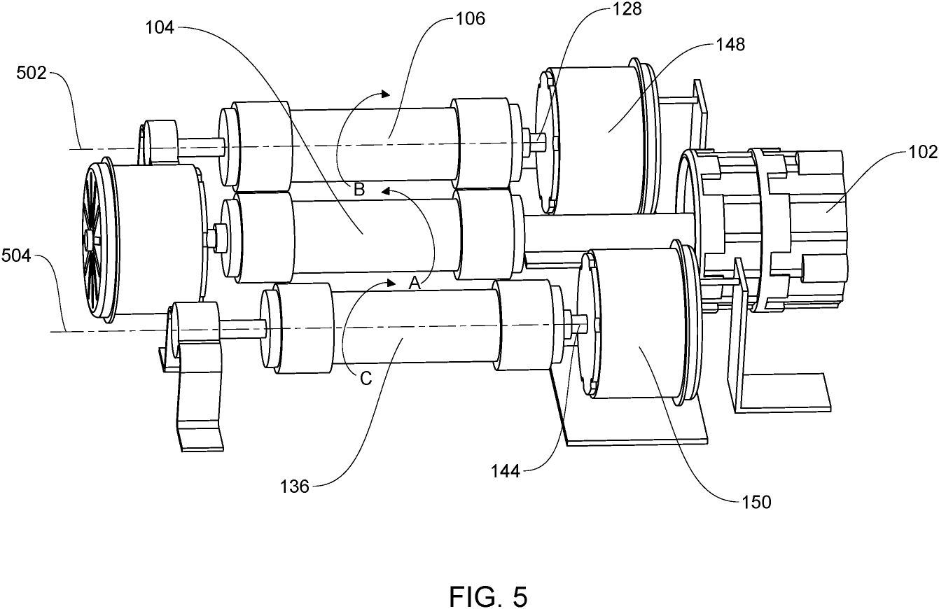

The second cylindrical body 106 includes a second cylindrical cavity. The second cylindrical body 106 has a second cylindrical body longitudinal axis (502, shown in FIG. 5). The second cylindrical body 106 includes a first end wall 122 opposite a second end wall 124.

In a preferred embodiment, the second cylindrical body 106 is concentrically disposed between a first driven axle 126 and a second driven axle 128. The first driven axle 126 is terminally and concentrically connected to the first end wall 122 of the second cylindrical body 106. The second driven axle 128 is terminally and concentrically connected to the second end wall 124 of the second cylindrical body 106.

Rotation of the first cylindrical body 104 in a clockwise direction A, imparts a corresponding counterclockwise rotation B of the second cylindrical body 106. The rotation of the second cylindrical body 106 with respect to the first cylindrical body 104 is explained in detail in conjunction with FIG. 5 of the present invention. The first cylindrical body 104 and the second cylindrical body 106 is explained in detail in conjunction with FIG. 2 of the present invention.

In a preferred embodiment, the magnetic gear system 100 includes an electrical generator 130 and a first cylindrical body driven axle 132. The first cylindrical body driven axle 132 is disposed between the electrical generator 130 and the second end wall 118 of the first cylindrical body 104. The electric generator 130 is operatively connected to the first cylindrical body driven axle 132.

Further, the electrical generator 130 is electrically connected to a controller 134 adapted to regulate a transmission of electricity through the controller 134. Examples of the electrical generator 130 include but not limited to Homopolar generator, Magnetohydrodynamic (MHD) generator, Induction generator, Linear electric generator and Variable-speed constant-frequency generators. Examples of the controller 134 include but not limited to a Flow controller, a Level controller, a Pressure controller, a Programmable Logic controller and a Universal Process/Temperature controller. Examples of the electric motor 102 include but not limited to a DC motor, brushless motor etc.

In another embodiment of the invention, the magnetic gear system 100 preferably includes a third cylindrical body 136 defining a third cylindrical cavity. The third cylindrical body 136 has a third cylindrical body longitudinal axis (504, shown in FIG. 5). The third cylindrical body 136 includes a third rectangular magnet disposed within the third cylindrical cavity. The third cylindrical body 136 includes a first end wall 138 opposite a second end wall 140. In a preferred embodiment, the third cylindrical body 136 is concentrically disposed between a third driven axle 142 and a fourth driven axle 144.

The third driven axle 142 is terminally and concentrically connected to the first end wall 138 of the third cylindrical body 136. The fourth driven axle 144 is terminally and concentrically connected to the second end wall 140 of the third cylindrical body 136.

In another embodiment of the present invention, the magnetic gear system 100 includes a battery 146 to power the electric motor 102. Examples of the battery 146 include but not limited to a Lead Acid battery, a Nickel-cadmium battery, a Nickel-metal-hydride battery and/or a Lithium-ion battery.

In one embodiment, the magnetic gear system 100 further includes an electrical generator 148 operatively connected to the first driven axle 126 of the second cylindrical body 106. Further, in another embodiment, the system 100 includes an electrical generator 150 operatively connected to the third driven axle 142 of the third cylindrical body 136. Preferably, each of the electric generators 130, 148 and 150 are electrically connected to the controller 134 adapted to regulate a transmission of electricity through the controller 136.

FIG. 2 is a perspective view of a first cylindrical body 104, in accordance with embodiments of the invention. As illustrated in FIG. 2, the first cylindrical body 104 includes a first cylindrical body longitudinal axis 202. The first cylindrical body 104 rotates on axis on receiving rotational power from the electric motor 102 via the first rotatable drive shaft 108. The structure of second cylindrical body 106 and the third cylindrical body 136 are identical to the first cylindrical body 104.

FIG. 3 is an open view of the first cylindrical body 104 in accordance with embodiments of the invention. As illustrated in FIG. 3, the first cylindrical body 104 defines a first cylindrical cavity 302. Preferably, the magnetic cylinder gear system 100 includes at least a first rectangular magnet 304 concentrically disposed within the first cylindrical cavity 302 of the first cylindrical body 104. The first rectangular magnet 304 comprises a longitudinal axis 306 that is in co-axial alignment with the first cylindrical body’s longitudinal axis (202, shown in FIG. 2).

Similar to the first rectangular magnet 304, the second rectangular magnet 702 and the third rectangular magnet 802 are respectively disposed within the second cylindrical cavity 704 of the second cylindrical body 106 and within the third cylindrical cavity 802 of the third cylindrical body 136, respectively. From the disclosure herein, it would be readily apparent to those skilled in the art that either a single magnet block 702 or multiple magnet blocks (702a, 702a, 702c) is/are disposed in the second cylindrical body 106, and that either a single magnet block 802 or multiple magnet blocks 802a, 802a, 802c is/are disposed in the third cylindrical body 136, without deviating from the scope of the disclosed invention.

The first rectangular magnet 304 includes a North polarity N opposite a South polarity S. The first rectangular magnet 304 includes a dividing line between the North polarity N and the South polarity S. The dividing line of the first rectangular magnet 304 is in co-axial alignment with the cylindrical body longitudinal axis (202, as shown in FIG. 2).

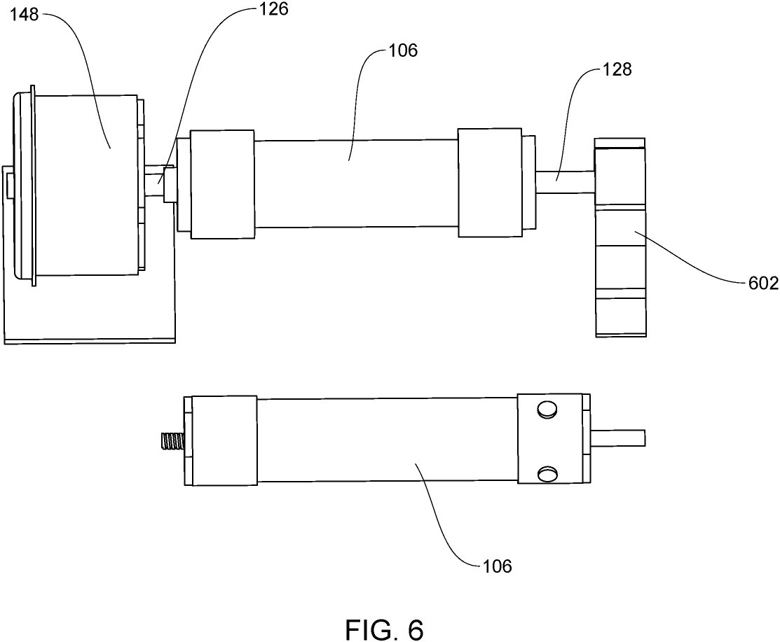

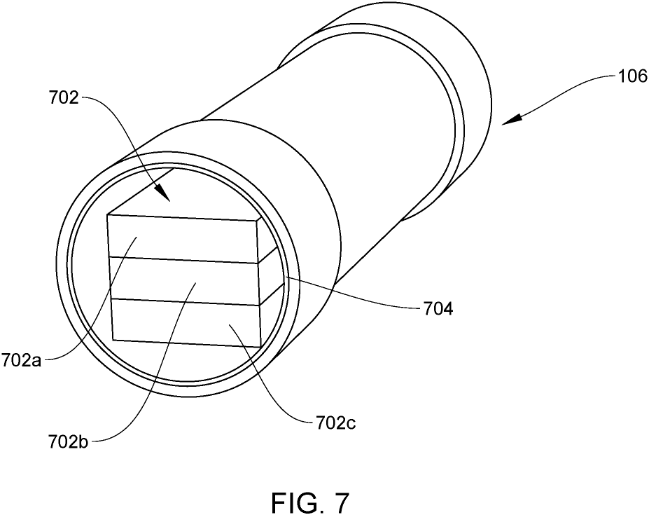

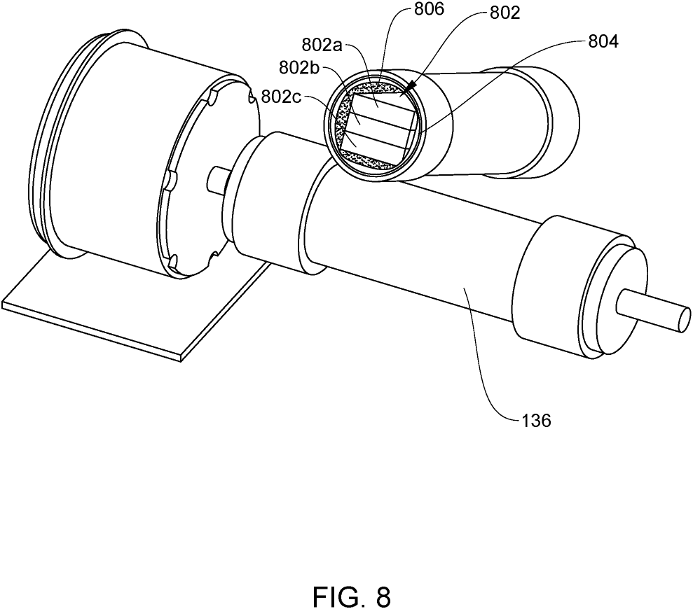

In a preferred embodiment, the first rectangular magnet 304 is a large block of a magnet, preferably as a single rectangular block magnet, having an opposite polarity on opposing sides. However, it would be readily apparent to those skilled in the art that various size and plurality of magnets may be placed in the cylindrical cavity (e.g., 704, 804), without deviating from the scope of the disclosed invention. For instance, in one embodiment, a placement of multiple rectangular block magnets in a stacked arrangement is shown in FIG. 6 and FIG. 7 of the invention.

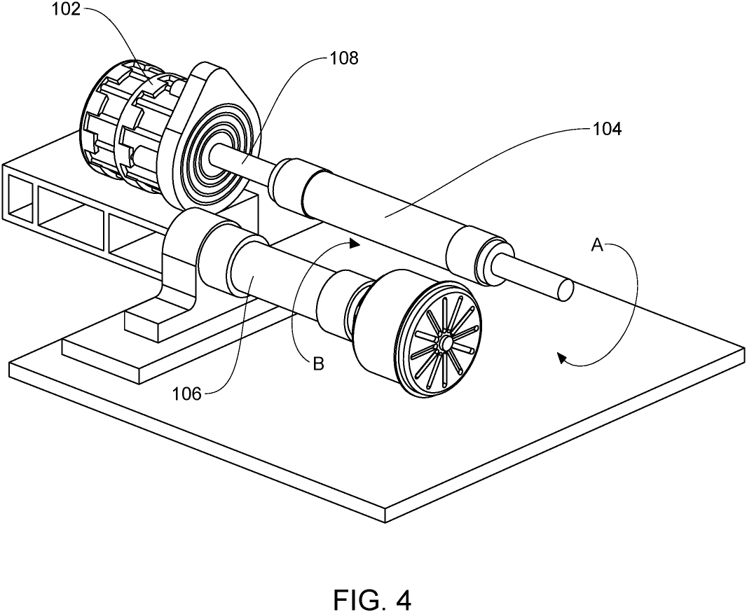

FIG. 4 illustrates a perspective view of arrangement of the first cylindrical body 104 in close proximity to the second cylindrical body 106, where the first cylindrical body 104 is connected to the electric motor 102. The first cylindrical body 104 is attached to the electric motor 102 via the first rotatable drive shaft 108.

As illustrated in FIG. 4, the first cylindrical body 104 is being positioned closely adjacent the second cylindrical body 106, such that in an initial position, the North polarity (N, shown in FIG. 3) of the at least first rectangular magnet 304 imparts magnetic attraction to the South polarity of the at least second rectangular magnet 702 that is disposed within the second cylindrical body 106. In a rotated position, the South polarity (S, shown in FIG. 3) of the at least first rectangular magnet 304 imparts magnetic attraction to the North polarity of the at least second rectangular magnet 702 of the second cylindrical body 106 such that a rotation of the first cylindrical body 104 in a clockwise direction (A, shown in FIG. 1) imparts a corresponding counterclockwise rotation (B, shown in FIG. 1) of the second cylindrical body 106. As exemplified in FIGS. 1 and 4, in one embodiment, the electric generator 148 produces electrical energy in the form of electricity upon the rotation by the electric motor 102 of the first cylindrical body 104 in a clockwise direction A imparting the corresponding counterclockwise rotation B of the second cylindrical body 106. Accordingly, energy is transferred from the electric motor 102 through the first cylindrical body 106 to the second cylindrical body 106 and thence into the electric generators 148, without any mechanical connection (such as intermeshing spur gears) between the first cylindrical body 104 and the second cylindrical body 106, through embodiments of the invention disclosed herein.

In another embodiment, the second cylindrical body 106 is connected to a transmission system of a vehicle, such as an axle of a motor vehicle or to an axle mount of a helicopter blade, and the rotation by the electric motor 102 of the first cylindrical body 104 in a clockwise direction (A, shown in FIG. 1) imparts the corresponding counterclockwise rotation (B, shown in FIG. 1) of the second cylindrical body 106; and accordingly, power is transferred from the electric motor 102 through the first cylindrical body 106 to the second cylindrical body 106 and thence into the transmission system of the vehicle, without any mechanical connection between the first cylindrical body 104 and the second cylindrical body 106, through embodiments of the invention disclosed herein.

FIG. 5 illustrates a perspective view of a preferred arrangement of the first cylindrical body 104, the second cylindrical body 106 and the third cylindrical body 136. The first cylindrical body 104 is positioned closely adjacent the third cylindrical body 136 such that in an initial position the North polarity of the at least first rectangular magnet 304 imparts magnetic attraction to the South polarity of the at least third rectangular magnet 802 that is disposed within the third cylindrical body 136; and in a rotated position, the South polarity of the at least first rectangular magnet 304 imparts magnetic attraction to the North polarity of the at least third rectangular magnet 802 of the third cylindrical body 136, such that a rotation of the first cylindrical body 104 in a clockwise direction (A, shown in FIG. 1) imparts a corresponding counterclockwise rotation C of the third cylindrical body 136.

Referring to FIG. 5, in another embodiment, the electric generator 148 is operatively connected to the second driven axle 128 of the second cylindrical body 106. Similarly, the electric generator 150 is operatively connected to the fourth driven axle 144 of the third cylindrical body 136. As described herein and illustrated in FIGS. 1 and 5, in a preferred embodiment, each of the electric generators 148 and 150 produces electrical energy in the form of electricity upon the rotation by the electric motor 102 of the first cylindrical body 104 in a clockwise direction A imparting the corresponding counterclockwise rotation B of the second cylindrical body 106 and also imparting the corresponding counterclockwise rotation C of the third cylindrical body 136; and accordingly, energy is transferred from the electric motor 102 through the first cylindrical body 106 to the second cylindrical body 106 and to the third cylindrical body 136 and thence into electric generators 148 and 150, without any mechanical connection between the first cylindrical body 104 and the second cylindrical body 106, and without any mechanical connection (such as intermeshing spur gears) between the first cylindrical body 104 and the third cylindrical body 106, through embodiments of the invention disclosed herein.

FIG. 6 illustrates a perspective view of the second cylindrical body 106 in an embodiment of the present invention. The electrical generator 148 is operatively connected to the first driven axle 126 of the second cylindrical body 106. The second driven axle 128 is rested on a clamp 602. In a preferred embodiment, the second driven axle 128 is rotatably mounted to the clamp 602, as exemplified in FIG. 6, where the second driven axle 128 is freely spinnable, or rotatable, within that clamp 602.

FIG. 7 is an open view of the second cylindrical body 106 in accordance with embodiments of the invention. In a preferred embodiment, a second cylindrical magnet 702 is disposed within a second cylindrical cavity 704. In one embodiment, the second rectangular magnet 702 includes a plurality of coaxially aligned second rectangular magnets 702a, 702b, and 702c, and each rectangular magnet 702 of the plurality of coaxially aligned second rectangular magnets 702 is positioned in a coplanar alignment, as illustrated in FIG. 7.

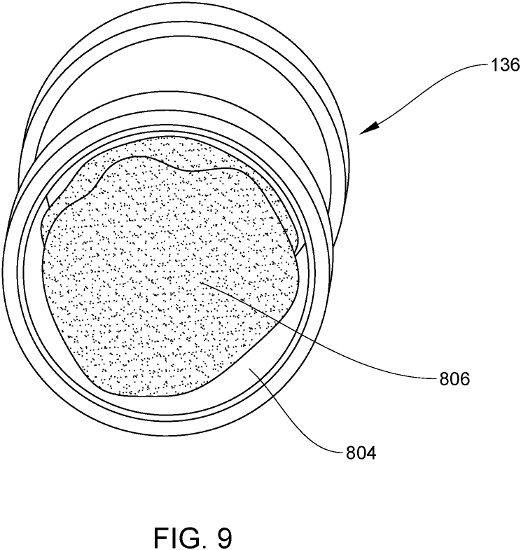

FIG. 8 and FIG. 9 illustrates an open view of the third cylindrical body 136 in accordance with embodiments of the invention. In a preferred embodiment, a third cylindrical magnet 802 is disposed within a third cylindrical cavity 804 of the third cylindrical body 136. In one embodiment, the third rectangular magnet 802 includes a plurality of coaxially aligned third rectangular magnets 802a, 802b, and 802c, and each rectangular magnet 802 of the plurality of coaxially aligned third rectangular magnet 802 is positioned in a coplanar alignment, as illustrated in FIG. 8.

Further, as shown in FIG. 8, preferably, a stabilizing material 806 is disposed in the third cylindrical cavity 804, surrounding the third rectangular magnet 802. Further, as exemplified in FIG. 9, the stabilizing material 806 is disposed on and around the third rectangular magnet 802 (not visible in FIG. 9) within the third cylindrical cavity 804 of the third cylindrical body 136.

It would be readily apparent to those skilled in the art that various type of stabilizing material such as pure cotton fiber, polystyrene, foam, and the like are envisioned without deviating from the scope of the present invention. The stabilizing material 806 is also used as binding materials because of good mechanical strength and insulating quality.

It would also be readily apparent to those skilled in the art that stabilizing material, such as the stabilizing material 806, is also preferably disposed in the first cylindrical cavity 704 of the first cylindrical body 104 and the second cylindrical body 106 around the respective magnets disposed therein without deviating from the scope of the present invention.

The drawings and the forgoing description give examples of embodiments. Those skilled in the art will appreciate that one or more of the described elements may be very well combined into a single functional element. Alternatively, certain elements may be split into multiple functional elements. Elements from one embodiment may be added to another embodiment. For example, the orders of the processes described herein may be changed and are not limited to the manner described herein. Moreover, the actions of any flow diagram need not be implemented in the order shown; nor do all of the acts necessarily need to be performed.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

Thus, the scope of the present disclosure is defined by the appended claims and includes both combinations and sub-combinations of the various features described hereinabove as well as variations and modifications thereof, which would occur to persons skilled in the art upon reading the foregoing description.

Numerous variations, whether explicitly given in the specification or not, such as differences in structure, dimension, and use of material, are possible. Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The claimed invention is:

1. A magnetic cylinder gear system comprising:
an electric motor having at least a first rotatable drive shaft having a proximal end opposite a distal end, said proximal end operatively connected to the electric motor;
a first cylindrical body defining a first cylindrical cavity, said first cylindrical body having a first cylindrical body longitudinal axis, said first cylindrical body comprising a first end wall opposite a second end wall, said distal end of the at least first rotatable drive shaft terminally and concentrically connected to the first end wall of the first cylindrical body;
at least a first rectangular magnet concentrically disposed within the first cylindrical cavity of the first cylindrical body, said at least first rectangular magnet having a longitudinal axis in co-axial alignment with the first cylindrical body longitudinal axis,
wherein said at least first rectangular magnet comprises North polarity opposite a South polarity,
wherein said at least first rectangular magnet comprises a dividing line between said North polarity and said South polarity
wherein said dividing line of said first rectangular magnet is in co-axial alignment with the cylindrical body longitudinal axis;
a second cylindrical body defining a second cylindrical cavity, said second cylindrical body having a second cylindrical body longitudinal axis, said second cylindrical body comprising a first end wall opposite a second end wall, said second cylindrical body concentrically disposed between a first driven axle and a second driven axle, said first driven axle terminally and concentrically connected to the first end wall of the second cylindrical body, said second driven axle terminally and concentrically connected to the second end wall of the second cylindrical body;
at least a second rectangular magnet concentrically disposed within the cylindrical cavity of the second cylindrical body, said at least second rectangular magnet having a longitudinal axis in co-axial alignment with the second cylindrical body longitudinal axis,
wherein said at least second rectangular magnet comprises a North polarity opposite a South polarity,
wherein said at least second rectangular magnet comprises a dividing line between said North polarity and said South polarity,
wherein said dividing line of said second rectangular magnet is in co-axial alignment with the second cylindrical body longitudinal axis;
the first cylindrical body being positioned closely adjacent the second cylindrical body such that in an initial position the North polarity of the at least first rectangular magnet imparts magnetic attraction to the South polarity of the at least second rectangular magnet and in a rotated position the South polarity of the at least first rectangular magnet imparts magnetic attraction to the North polarity of the at least second rectangular magnet such that a rotation of the first cylindrical body in a clockwise direction imparts a corresponding counterclockwise rotation of the second cylindrical body.

2. The magnetic gear system of claim 1, further comprising an electrical generator operatively connected to a first cylindrical body driven axle, said electrical generator electrically connected to a controller adapted to regulate a transmission of electricity through said controller.

3. The magnetic gear system of claim 1, further comprising an electrical generator operatively connected to the first driven axle of the second cylindrical body, said electrical generator electrically connected to a controller adapted to regulate a transmission of electricity through said controller.

4. The magnetic gear system of claim 1, further comprising an electrical generator operatively connected to the second driven axle of the second cylindrical body, said electrical generator electrically connected to a controller adapted to regulate a transmission of electricity through said controller.

5. The magnetic gear system of claim 1, wherein said first cylindrical body longitudinal axis is parallel to said second cylindrical body longitudinal axis.

6. The magnetic gear system of claim 1, further comprising a third cylindrical body and at least a third rectangular magnet,
said third cylindrical body defining a third cylindrical cavity, said third cylindrical body having a third cylindrical body longitudinal axis, said third cylindrical body comprising a first end wall opposite a second end wall, said third cylindrical body concentrically disposed between a third driven axle and a fourth driven axle,
said third driven axle terminally and concentrically connected to the first end wall of the third cylindrical body, said fourth driven axle terminally and concentrically connected to the second end wall of the third cylindrical body,
said at least third rectangular magnet concentrically disposed within the cylindrical cavity of the third cylindrical body, said at least third rectangular magnet having a longitudinal axis in co-axial alignment with the third cylindrical body longitudinal axis,
wherein said at least third rectangular magnet comprises a North polarity opposite a South polarity,
wherein said at least third rectangular magnet comprises a dividing line between said North polarity and said South polarity,
wherein said dividing line of said third rectangular magnet is in co-axial alignment with the third cylindrical body longitudinal axis;
the first cylindrical body being positioned closely adjacent the third cylindrical body such that in an initial position the North polarity of the at least first rectangular magnet imparts magnetic attraction to the South polarity of the at least third rectangular magnet and in a rotated position the South polarity of the at least first rectangular magnet imparts magnetic attraction to the North polarity of the at least third rectangular magnet, such that a rotation of the first cylindrical body in a clockwise direction imparts a corresponding counterclockwise rotation of the third cylindrical body.

7. The magnetic gear system of claim 6, wherein the third cylindrical body longitudinal axis is parallel to both of said first cylindrical body longitudinal axis and said second cylindrical body longitudinal axis.

8. The magnetic gear system of claim 7, further comprising an electrical generator operatively connected to the third driven axle of the third cylindrical body, said electrical generator electrically connected to a controller adapted to regulate a transmission of electricity through said controller.

9. The magnetic gear system of claim 7, further comprising an electrical generator operatively connected to the fourth driven axle of the third cylindrical body, said electrical generator electrically connected to a controller adapted to regulate a transmission of electricity through said controller.

10. The magnetic gear system of claim 1, wherein the at least first rectangular magnet comprises a plurality of coaxially aligned rectangular magnets, each rectangular magnet of said plurality of coaxially aligned rectangular magnets being positioned in coplanar alignment.

11. The magnetic gear system of claim 1, wherein the at least second rectangular magnet comprises a plurality of coaxially aligned rectangular magnets, each rectangular magnet of said plurality of coaxially aligned rectangular magnets being positioned in coplanar alignment.
